(19) United States
(12) Patent Application Publication
(10) Pub. No.: US 2008/0276234 A1
(43) Pub. Date: Nov. 6, 2008

(54) Data center edition system and method

(75) Inventors: Jacob Taylor, Santa Clara, CA (US); John Roberts, San Jose, CA (US); Clinton Oram, San Mateo, CA (US); Lila Alexei Tretikov, Los Gatos, CA (US); Joseph L. Parsons, Austin, TX (US); Sadek Baroudi, San Jose, CA (US)

Correspondence Address: DLA PIPER US LLP, 2000 UNIVERSITY AVENUE, E. PALO ALTO, CA, 94303-2248, US

(73) Assignee: SugarCRM Inc., Cupertino, CA (US)

(21) Appl. No.: 12/100,322

(22) Filed: Apr. 9, 2008

Related U.S. Application Data
(63) Continuation-in-part of application No. 11/732,321, filed on Apr. 2, 2007.
(60) Provisional application No. 60/922,606, filed on Apr. 9, 2007.
(60) Provisional application No. 60/977,521, filed on Oct. 4, 2007.

(51) Int. Cl. G06F 9/445

(52) U.S. Cl. 717/177

(57) ABSTRACT

A data center edition system and method are provided.

### PRIORITY CLAIM/RELATED APPLICATIONS

This application claims the benefit of/priority under 35 USC 119(e) and 35 USC 120 to U.S. Provisional Patent Application Ser. No. 60/922,606 filed on Apr. 9, 2007 and entitled “Data Center Edition System and Method” and to U.S. Provisional Patent Application Ser. No. 60/977,521 filed on Oct. 4, 2007 and entitled “Data Center Edition System and Method”, both of which are incorporated herein by reference in their entirety.

In addition, this application also claims priority under 35 USC 120 and is a continuation in part of U.S. patent application Ser. No. 11/732,321, filed on Apr. 2, 2007 and entitled “Application Clustering System and Method” which in turn claims priority under 35 USC 119(e) and 120 to U.S. Provisional Patent Application Ser. No. 60/787,975 filed on Mar. 31, 2006 and entitled “Application Clustering System and Method”, both of which are incorporated herein by reference in their entirety.

### APPENDIX

Appendix A is a spreadsheet showing the seed data for an Account table of the SugarSuite system. Appendix A forms part of this specification.

### FIELD

A software-based system is described and in particular a system and method for deploying a software-based system using one or more hardware components are described.

### BACKGROUND

The deployment of a single user/single enterprise software-based system is relatively straight-forward in that the software is installed on a computer and executed on that computer. The deployment of a software-based system across a wide geographic area is more difficult since it is not possible to have a single installation of the software due to network latency and other issues. Thus, it is desirable to provide a data center edition system and method and it is to this end that the system and method are directed.

### SUMMARY

An application clustering system and method are provided wherein the system may include a set of geographically distributed nodes (where each node is typically composed of a cluster of servers). In addition, each customer instance is served by a primary node, with hot stand-by nodes in different locations. The system may also have data centers in US East, US West, and Europe each hosting multiple nodes for capacity growth and fault isolation. The system may also include storage area network and network storage appliance units in each node for high performance and storage reliability.

### BRIEF DESCRIPTION OF THE DRAWINGS

FIG. 1 illustrates an application clustering system;

FIG. 2 illustrates more details of the server cluster of the application clustering system shown in FIG. 1;

FIGS. 3A and 3B illustrate a high level diagram of the network layer of the server cluster of the application clustering system;

FIG. 4 illustrates deployment of an application in a data center edition (DCE) environment system;

FIG. 5 illustrates a partial database schema for a table of an application in the DCE system;

FIG. 6 illustrates a template sandbox upgrade method of the DCE system;

FIG. 7 illustrates a template quick upgrade method of the DCE system;

FIG. 8 illustrates a source and sandbox environment of the DCE system; and

FIG. 9 illustrates a centralized scheduler for the DCE system.

### DETAILED DESCRIPTION OF ONE OR MORE EMBODIMENTS

The system is particularly applicable to a customer relationship management software application system (a SugarCRM system) and it is in this context that the system will be described. It will be appreciated, however, that the clustering system and method in accordance with the invention has greater utility since the clustering system may be used with a variety of software applications wherein those software applications benefit from the clustering system and method.

An example of an exemplary embodiment of the application clustering system may be the Sugar On-Demand system which is a product offering from SugarCRM Inc. The Sugar On-Demand system is a scalable grid of computers around the globe working together to provide a seamless user experience for millions of end-users. Each node in the grid is itself an independent installation of Sugar On-Demand. These nodes, when coordinated, can provide disaster recovery for each other. The system uses well known, typical components as much as possible to avoid specialist knowledge, avoid the cutting edge, and keep predictability and reliability high.

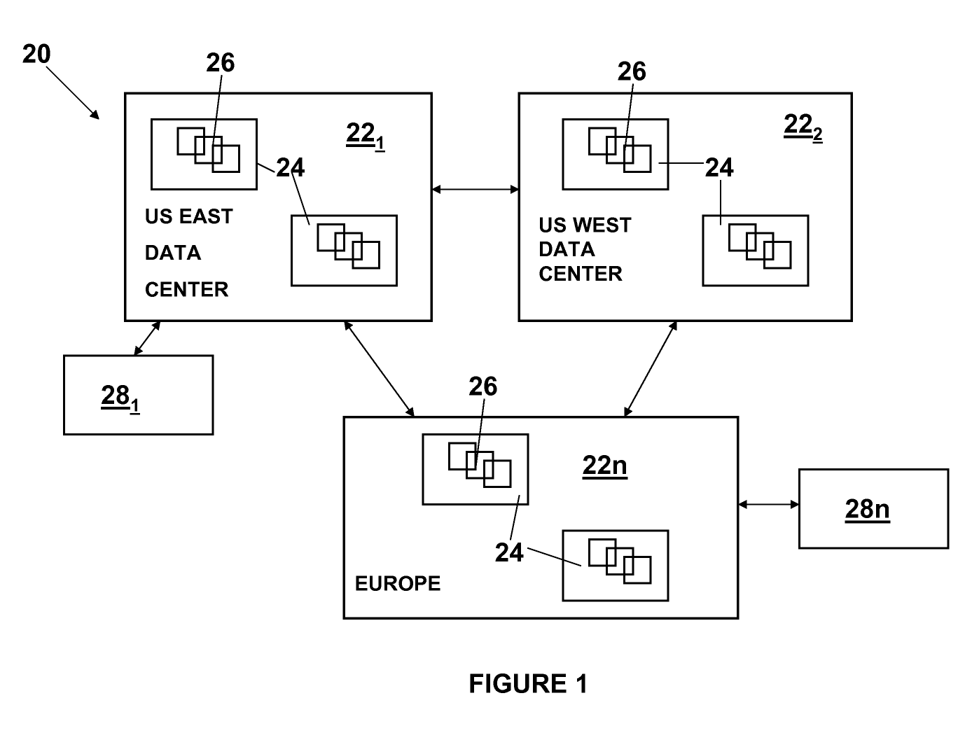

FIG. 1 illustrates an application clustering system 20. The system 20 may have one or more data centers 22 (such as a US East data center 22₁, a US West data center 22₂ and a Europe data center 22ₙ in the example shown) that may be geographically distributed and coupled to each other over communications links, such as a computer networks, communications networks, cellular networks, WiFi networks, etc. so that the data centers can exchange data and information with each other. Each data center may host one or more nodes 24. The capability to support one or more nodes in a data center provides for easy capacity growth and fault isolation. Multiple data centers should be geographically distributed to provide instances located near the end users (to provide more efficient transmission of data) and provide further fault isolation. Each node 24 may further comprise a cluster of servers 26. Each customer instance 28, such as customer instance 28₁ and 28n shown, is served by a primary node, with hot stand-by nodes in different locations (for fault isolation) available as needed. Each customer instance, in the embodiment, is an installation of the SugarCRM customer relationship management software application that is used by the people associated with the customer instance. The system 20 may further comprise well known storage area network and network storage appliance units in each node for high performance and storage reliability. The system 20 shown provides fault isolation because, if a primary node of a customer instance in a particular data center fails (maybe due to a problem with the data center or its connectivity), the backup node or nodes for the particular customer instance is located in a different data center in a different location so that it is more likely that the backup node will be able to take over when the primary node fails.

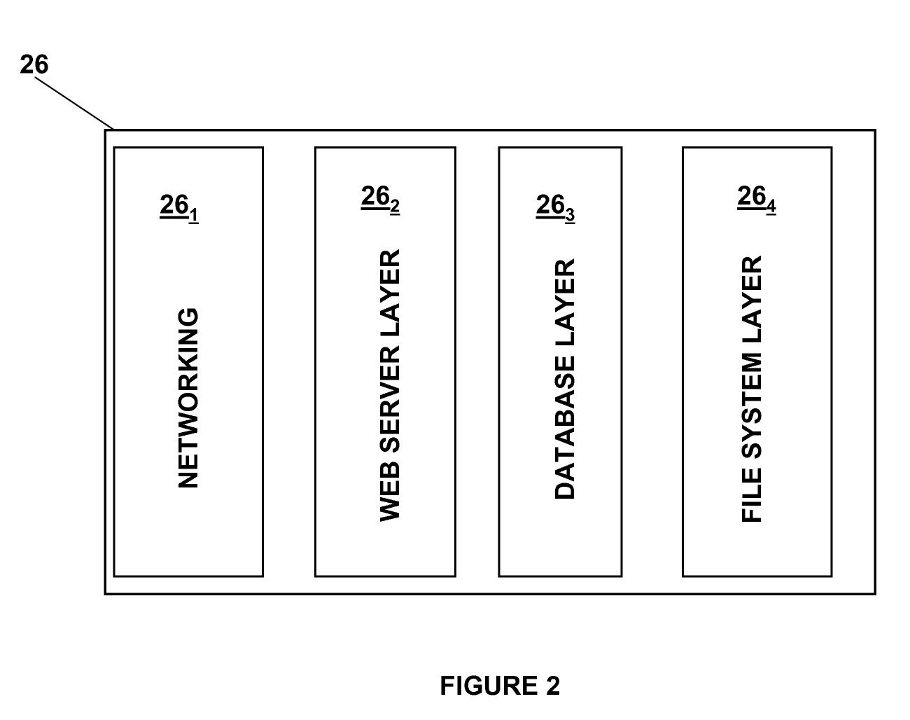

FIG. 2 illustrates more details of the server cluster 26 of the application clustering system shown in FIG. 1. Each cluster of servers 26 may include four layers including a Networking layer 26₁, a Web Server layer 26₂, a Database layer 26₃, and a File System layer 26₄.

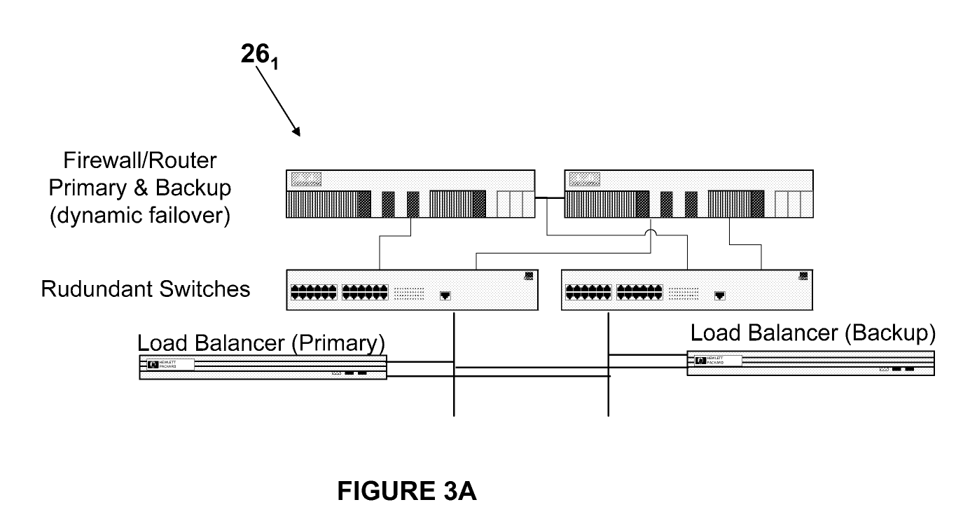

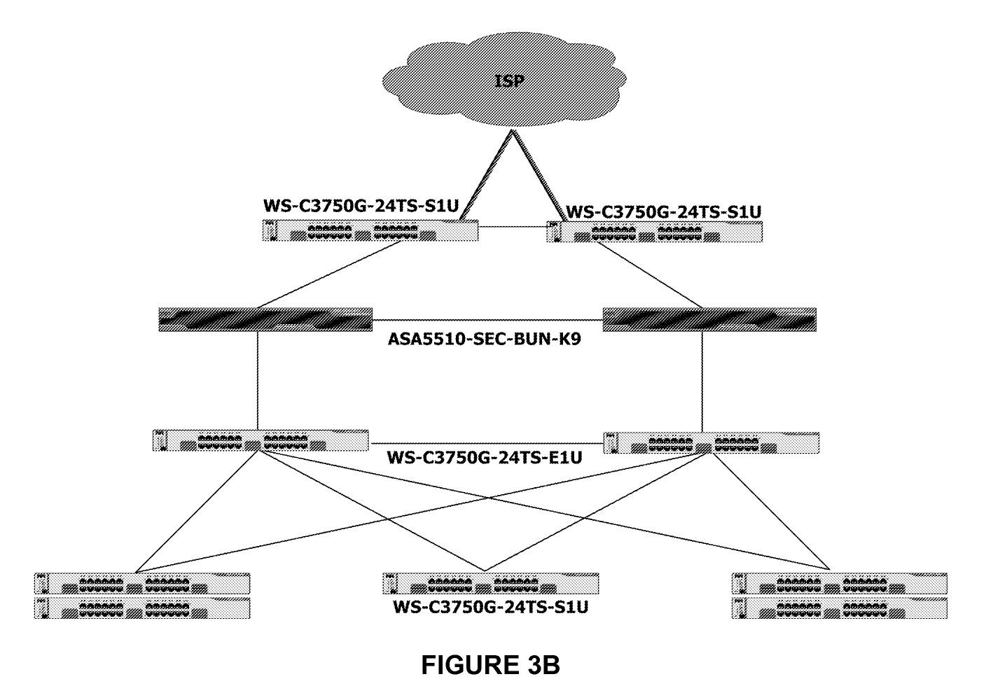

Each layer may be implemented by a computing device, such as a server computer or any other processing unit based device, that has the typical server computer components and executes one or more software applications as described below. The Networking layer consists of the firewalls, switches, and load balancers as shown in FIGS. 3A and 3B. The Web layer consists of the web servers running the software applications, such as applications like SugarCRM in one example. The Database layer consists of database servers that store the applications and the data and information associated with the applications. The File System layer consists of a managed file system. It is preferred if the file system in the File System layer is cluster aware and automatically replicates itself among the appropriate nodes.

FIGS. 3A and 3B illustrate a high level diagram of the network layer 26₁ of the server cluster 26 of the application clustering system. The networking layer is primarily responsible for making sure that the correct level of access is provided, providing appropriate connectivity between the machines, balancing load among the servers, and assisting in failover. An example of the architecture of the networking layer is shown in FIGS. 3A and 3B. Each server in a cluster (a machine) should have redundant network connections to redundant switches and all of the machines should be connected by at least a 1 gigabit network. In the network layer, firewalls network monitoring devices may be used to protect the network from intrusion. For normal operation, only https and http traffic needs to be allowed, SSH is also desirable for system management but is not required. If SSH is supported, it can be done using a non-standard port which will decrease the number of attacks received on the applications. The network switches shown in FIG. 1 perform routing, connectivity, and monitoring, although they may also have the capacity to detect failure and swap over to the redundant hardware.

Each load balancer serves three primary purposes. Each of these purposes is implemented by one or more lines of computer code that are executed by a processing unit in the load balancer unit that implement the purposes described below. First, it serves its traditional function, sharing load among the multiple machines in a single layer. For many systems, it is desirable to have session affinity turned on. PHP (a known scripting language used to create dynamic web pages) session IDs are passed in cookies (or the URL if cookies are disabled) and should be available on every request. There are two ways to share sessions that will not require, but still may benefit from, session affinity. A shared file system, in which the sessions are stored, would make affinity redundant. Having cluster aware software that coordinates the sessions and makes them available to the entire layer would also render affinity redundant. Having most requests from one session go to one web server allows for better use of cache. Each round trip for dynamic content needs the session information in order to complete. If the session information is already cached on the server, then it does not have to be retrieved from the shared storage.

The second main purpose of the load balancer is to provide automatic failover to an alternate system should one of the primary systems fail. This can be failover between network cards, switches, or an entire server or node that is no longer functioning or is overloaded. Ideally monitored system load metrics would also be used as criteria for switching between machines.

The final main purpose of the load balancer is to encrypt and decrypt SSL communications. Leveraging SSL provides enhanced security for critical data. Using the load balancer to encrypt/decrypt the traffic is a good way to make sure the enhanced security does not come at the cost of too much server load.

In most configurations, there will only be one layer of web servers. They can be on an isolated network, and barring the discussion of affinity above, they can be considered identical. Only real-time system load and affinity requirements need to be analyzed when routing requests. To this end, there only needs to be one virtual IP for the web servers in each node. All web server requests should go to this IP.

The database layer needs the ability to communicate among the servers internally, reach the file system, and be reachable from the web server layer on specified ports. The load balancing of the databases is a little trickier than load balancing the web servers. There should be two virtual IPs for database servers, one for the master, one for a slave. As long as the slaves are responding, any slave should be able to process any read only request. If a master fails, the backup master must be activated as the new master. If the master comes back online, it should not automatically be put back as the master. The databases must be checked for consistency and most likely, the old master will be configured to be the backup master.

The web server layer needs to be reachable from the outside and needs to be able to reach the database layer. Servers in the web server layer need to be able to communicate with each other if there is cluster aware software running on the systems. If they are only leveraging a common file system, they do not need access to each other. The database layer needs to be reachable from the web server layer.

Since the traditional web and application layers have been collapsed, there are really only two layers of servers in a typical deployment. Traditional web servers can be used in the DMZ for static files and as proxies for added security if desired.

Proxy Server Layer

This system is designed to operate over huge geographic distances and networks may not provide sufficient bandwidth for a satisfactory user experience. In order to improve the end user experience, local web proxy servers may be used to provide several key benefits. Among the potential benefits are:
A huge reduction in long distance web server connections (connections are made to regional links)
A decrease in server load (since it is handling static content)
Much faster responses of static content
Able to keep more of the static content pre-compressed in a memory of the proxy server
Able to share established secure connections with the web servers among multiple different clients.
   In general, while the use of web proxies is not required they are a great way to boost end user performance. They can be deployed at any level, from regionally around the world all the way down to actually at the customer's location.

Web Server Layer

The web layer is typically composed of a grid of simple off the shelf systems running identical platform software with the application, such as SugarCRM in the preferred example, running on the systems. They must have a common application image in order for them to effectively form a SugarCRM cluster to function correctly. Processor and network throughput are the primary things to purchase for on this layer.

The web layer should leverage PHP accelerators. PHP accelerators save a lot of processing on the server side with every round trip. Traditionally, PHP re-parses all files on each round trip from scratch (only the operating system file cache provides any speedup). All PHP accelerators save intermediate states of page compilation and many have no PHP compilation after the first run, just execution processing. There are many accelerators on the market. The Zend Platform, for instance, has the ability to cache PHP in different states of processing, greatly decreasing the work on each round trip. It also has the ability to manage sessions across the cluster (keeping them in memory and only writing them to the file system for failure recovery). It also has the ability to efficiently transfer large files through PHP and cache generated output across sessions. Three other accelerators are APC, php-accelerator, and eAccelerator. The Zend Platform has been known to work well with Sugar under heavy load; the other accelerators are under testing.

Database Layer

The database layer will differ significantly depending on the database that you are using. From the application perspective, there needs to be at least one server IP Address and credentials that the application can use to read and write data. As the application evolves, it will have increasing ability to leverage read-only slaves from a cluster in order to remove hotspots from the cluster. The majority of a CRM application's queries are read only. Eventually, reporting database servers will be supported. These three layers of database servers can be collapsed transparently if the read-only servers or reporting servers fail or become unavailable.

With any supported database, there are a few common configuration Best Practices to consider. Persistent database connections should be enabled. This will save time spent connecting to the database on each round trip. Currently Sugar uses a single database connection for all queries in one round trip. The connection is made at the beginning of the page processing and is released at the very end. Protect the network between the web servers and the database server. This allows for the communication between web server and database to be unencrypted. This will also save processing power. The currently supported databases may include MySQL and Oracle.

MySQL

With MySQL, there are two primary replication options:

Master-Master configuration

Master-Slave configuration

All writes should go to a master. The system may be setup so that if the primary master were to fail, all of the slaves would replicate off of the backup master and all inbound queries would go to the backup master as well. Once the original master is ready to be put back into production, the cluster can be reconfigured to re-label the primary and backup masters or the primary master can be recovered.

For smaller configurations, the publicly available MyISAM is an excellent storage engine that performed well during testing and MyISAM is very fast and flexible. For larger systems, the publicly available InnoDB should be considered. In an ideal configuration, the master would leverage InnoDB and the slaves would leverage MyISAM. This configuration provides the enhanced locking and transaction capabilities of InnoDB while still allowing the speed, flexibility, and full-text search capabilities of the MyISAM engine. At the time of installation, it is highly recommended that an administrator set the default engine and code page to the values that the administrator wants the application, such as SugarCRM, to use.

Oracle

Oracle is a well-known database to the enterprise market and most enterprise companies have Oracle database administrators (DBAs) already on staff. For this reason, the example application (“Sugar”) supports both Oracle 9i and 10g databases. Sugar is configured to create all tables and indexes in the default tablespace of the user. It is recommended, however, that indexes are created in a different tablespace in order to reduce contention. At this time, the easiest way to accomplish this is to get a dump of all indexes, drop them, and then recreate them in another tablespace. In the future, the Sugar application will be ask for appropriate tablespace names during the installation process.

File System Layer

A Sugar Suite, that may be an installation of a suite of software applications that includes the SugarCRM customer relationship management application described above, is composed of many files. The files fall into one of several general categories. Each of the categories is detailed below along with approximate sizing.

Application Files

Application files are the primary files that compose the Sugar Suite. A clean install of 4.2 Professional or Enterprise are composed of roughly 6,000 files which take roughly 40 MB of disk space. These initial files are infrequently modified, but are frequently read. All application functionality is coded in these files.

Application Customizations

Application Customizations include new modules, new logic, override files, language packs, and any other enhancements made to the Sugar Suite at the file system level. These modifications would generally not be expected to be more than the same rough size as the initial application files. It is quite possible, however, that the customizations will be far larger than the base application.

Attachments

Attachments are one of the quickest growing segments of files in the application. The use of uploaded files is dependant on the use of the Sugar Suite by each enterprise. Some enterprises quickly end up with gigabytes of attachments; others only have megabytes of attachments after a long period of time. If the particular enterprise practices attaching files to opportunities, accounts, cases, bugs, etc., then it is highly recommend that the enterprise sets aside a good deal of storage space to accommodate the size of the attachments based on the business process. For example, SugarCRM Inc. (that distributes the Sugar Suite) recommends that at least 20 GB be ear-marked for this purpose at the time of installation and expand as needed over time. This approach will provide enough storage for most implementations in the beginning while providing visibility into actual usage allowing the enterprise to adjust and manage the filesystem appropriately.

An attribute of attachments is that they rarely change. Once a file is uploaded the application leaves it intact. As a Best Practice recommendation, it's a good idea to perform maintenance from time to time to clean out old files. Coincidentally, users expect a reasonable delay when retrieving an attachment. As such, attachments can be stored on slower disks in the SAN or on the inner part of the disks. For this reason, less expensive drive arrays can be used for the larger attachment folders since they will be less frequently accessed and users should have a higher tolerance for small delays (there is only one attachment per round trip as compared to possibly over one hundred read files for a normal page).

Cache Files

Cache files are generated by the application during normal processing. When a user requests a graph, for instance, the graph data is calculated and stored in an XML file. When they refresh their browser, the XML file is re-read instead of being recalculated. It is important that cache files for a particular session be available on the next round trip. This can be accomplished via a shared filesystem or session affinity with periodic file synchronization.

Logs

Log files during development, testing, and tuning can be quite large. In production, the log level is typically set to FATAL which drastically decreases the growth of log files. Log files are typically stored in the root of the application folder. When any kind of performance monitoring or tuning logs levels are in use, the log files are rather frequently updated. It is important that this not become a source of contention for a shared file system. To this end, each web server should have a local log that it writes to that is then later merged with the other logs (or copied to a common location).

Configuration Files

Configuration files rarely change. There are a few reasons why a user might want to have different configuration files for each of the web severs in a cluster. In general, all of the webserver(s) should be configured in the same manner.

Session Files

In a cluster of web servers, it is best if a cluster session manager is used in which case a shared file system can be used to store a copy of the session data in case of system failure. If a cluster session manager is not used, the user can store all of the sessions in a shared files system. The session files are read and written on each round trip to the database. In addition, the data from the last round trip may be present when processing the next round trip (i.e. the cluster file system must operate as a single global file system for session files).

The application clustering system may also provide redundancy to each cluster including network redundancy, power redundancy, database redundancy, server capacity, file system capacity, monitoring redundancy, multi-site redundancy, backups and adverse condition strategies. The adverse condition strategies may include a notification plan for virus attack, massive hardware failure, local catastrophe, DDOS Attack, hack attempts, successful hacks, security vulnerability, customer load tests, poor customer customizations, operational maintenance and urgent unplanned maintenance. The redundancy provided by the system also may include regular maintenance.

The system may also provide capacity planning which may include capacity planning for the file system, for the network, for power, for space and for backup. For the file system, the capacity planning may include slow files (files such as uploaded content and cache folders.) They do not change often and can take a little while to retrieve (much longer than one of the PHP pages used in common UI responses), application files, application customizations, uploaded files, logs, configuration files and database files. The network capacity planning may include end-user, backup, sync and monitoring. The system may also provide rapid growth capacity planning.

The system may also provide access control that may include ION, customer databases, customer files and/or shell accounts. The system also may provide monitoring that may include simple repair actions that need to become automated, every round trip being logged, the file system, the database, the processing units (CPUs), system loads, memory, swap and ideally queries and stuff based on sampling.

The system may also provide rollout testing that may include how new versions or new scripts, etc are rolled out or the process to follow before pushing the update button. The system may also provide production, load testing, quality assurance (QA), a customer sandbox environment, security and a shared file system. The customer sandbox environment may give Customers and professional services (PS) people access to a sandbox to edit their application and give them the ability to reset their instance, or migrate changes into production. The security permits audits and change approval and tracking.

Each of the data centers 22 shown in FIG. 1 may include a data center edition application (DCE) system that encapsulates management, monitoring and deployment capabilities for, in one embodiment, a SugarSuite installation where the SugarSuite installation is a suite of software applications that includes the SugarCRM customer relationship management application described above. Each of the capabilities of the data center edition application (DCE) may be implemented, in one embodiment, as one or more lines of computer code that are executed by a processing unit of the computing device that executes the DCE application. For example, SugarSuite may be composed of:
Configuration Files—These files are used to extend, configure, and point the SugarSuite installation to resources it has available. Among other things, they may contain folder locations, template information, instance settings, and connection information for the database, file system, cache, . . . .

Uploaded Files—These are files that have been uploaded to the instance and potentially linked to records in the system. These files may include, but are not limited to: contracts, documents, images, logs, . . . .
Cache Files—These files are dynamically generated by the system and used to decrease the cost of repeated calculations. Template rendering frequently leverages caching to improve performance. Another good example of a cache file is a composition of metadata for sub-panels. For a detail view like the account detail view, there may be a collection of sub-panels under the detail view. Each module that would like to make a sub-panel available on the account detail view provides metadata. The system calculates the metadata for the entire view (based on the contributed metadata) and caches the output metadata in a cache file.
   Phantom file caching: non-existent file references may be cached to avoid spending resources on the unnecessary operations.
Application Files—These files are the basic application. All of the application logic is contained in application files. In the case of SugarSuite, the application files are typically .PHP files.
Log Files—The logs are critical for keeping track of system performance, tracking issues, and monitoring the system for errors or intrusion attempts.
Session Files—Sessions contain information about the user that is interacting with the system. Sessions may be stored in memory, on a dedicated server, in the database, or on disk. If the sessions are stored on disk, the session files will need to be stored where they are isolated from other instances of SugarSuite and available to PHP.
Temp Files—During the processing of the application, the system may need to create temporary files from time to time. These files are typically stored in a temporary folder to keep them isolated from the rest of the system.

Another aspect of the DCE system may be the ability to provide an intelligent cache designed to decrease the file system or processing load produced on or by the web servers. There are several different ways in which caching file accesses will decrease server load. One common issue in a system composed of components that reside in multiple folders where an included file can be located in one of many folders is determining which folder a file should be included from. In an instance of sugar in DCE, it is important that the system be able to quickly figure out which path a file comes from. To that end, a cache of the result of determining where a file is located, either by folder or by individual file, may be kept to help reduce redundant searches through the file system. Another common extension point in Sugar is the automatic inclusion of extension files if they are present. The implementation of this requires the system to frequently check to determine if a given file is present or not. If the file is present, this file is cached by the operating system. If the file is not present, this file is typically not cached by the operating system. This leads directly to disk load. The system may cache files that do not exist just like it caches the files that do exist. This cache would offload the file system and prevent it from performing complicated searches for files that, in the end, do not exist. The fact that the files do not exist may be stored by directories or filename.

The DCE system allows users to function as administrators of distributed installations of the Sugar application and view system and application related reports from within a unified application management console.

The DCE system may be comprised of several high-level features that include deployment composition, deployment management and license management, monitoring, alerts and reports and access control management. All of these features are subject to access control as well as general Search & Filter capabilities because this system must comply with all guidelines (including UI, design, administration, coding practices and frameworks) set forth by SugarSuite documentation available at www.sugarcrm.com which are incorporated herein by reference.

The DCE system can manage, monitor and deploy applications on the following platforms: Linux platforms (including the commercially available UBUNTU 6.1.0 and/or Red Hat Enterprise Linux (RHEL) 4.0), Windows Platforms (including XP, Vista, Longhorn and/or Windows 2000), databases (including MySQL 5.x, Oracle 10g and/or SQL server) and/or web servers (including Apache and/or IIS).

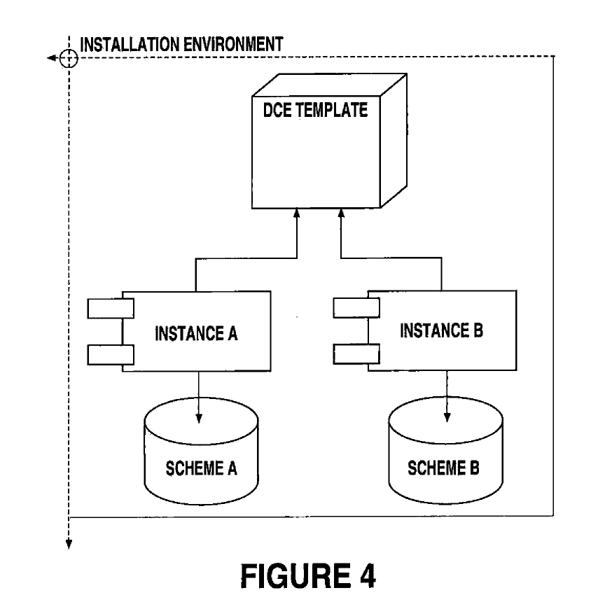

A deployment is a single instance of SugarSuite deployed in the DCE environment as shown in FIG. 4. A deployment may include the following properties: zero or more virtual host folders with all code and files specific to an instance of SugarSuite; zero or more links to the template folder to use with an instance (generic files for specific version of SugarSuite); and/or a database schema instance (could be seeded with data or empty); or a link to an existing database (DB) instance that can be a shared database. The environment of the deployment, as shown in FIG. 4, may include a DCE template that is used for one or more instances of the application, such as Instance A and Instance B as shown in FIG. 4 wherein each instance may be based on a database schema instance, such as schema A and schema B as shown in FIG. 4. Each instance is associated with a template so the templates->instance relationship is one-to-many.

Template Requirements and Management

Each template is either 1) an unmodified release and/or patch versions of a SugarSuite; or 2) customized releases specific for groups of users and possessing a specific and well-defined combination of features (such as for instance a Real Estate Template). The templates function as a generic code-base for a number of further customized instances. The instance customizations work by overriding the template version of a file via introducing a customer version in a sub-location. The SugarSuite software uses the customized file version if such version is available, or the generic “template” version otherwise.

Each template instance may have one or more of the following properties:
They will send NO heartbeats to a heartbeat server wherein the heartbeat server requires each installation to periodically ping the heartbeat server
Access to the Template & Configuration Files will be restricted to admin users only
Access to the Source Code will be restricted to admin users only
Access to the database will be restricted to admin users only; and/or
Automatically replicate usage information to a central database or directly use the central database for storing and retrieving that information.

Instance Management

The instances of SugarSuite are distinct instances of the SugarCRM application at distinct URLs generally created for a variety of purposes. Each instance must be based on one SugarSuite Template. A typical use of instances can include creating development, stage and production versions of an application. Each instance may have one or more of the following properties:
Each Instance will send heartbeats to the heartbeat server.
Each Instance will be associated with a Template and orphan instances are not allowed.
Access to the Source & Configuration files will be restricted to admin users only
Access to the Studio will be allowed for specific users
Access to the DB will be restricted to admin users only

SugarSuite Database Schema

Each SugarSuite Instance must be linked to a database schema as shown in FIG. 4. Each new installation of a SugarSuite instance must install a corresponding DB schema as well as to configure the Instance for DB access. The SugarSuite DB Schema may have the following properties:

Will be a complete SugarSuite Data schema.

Can be optionally seeded with data.

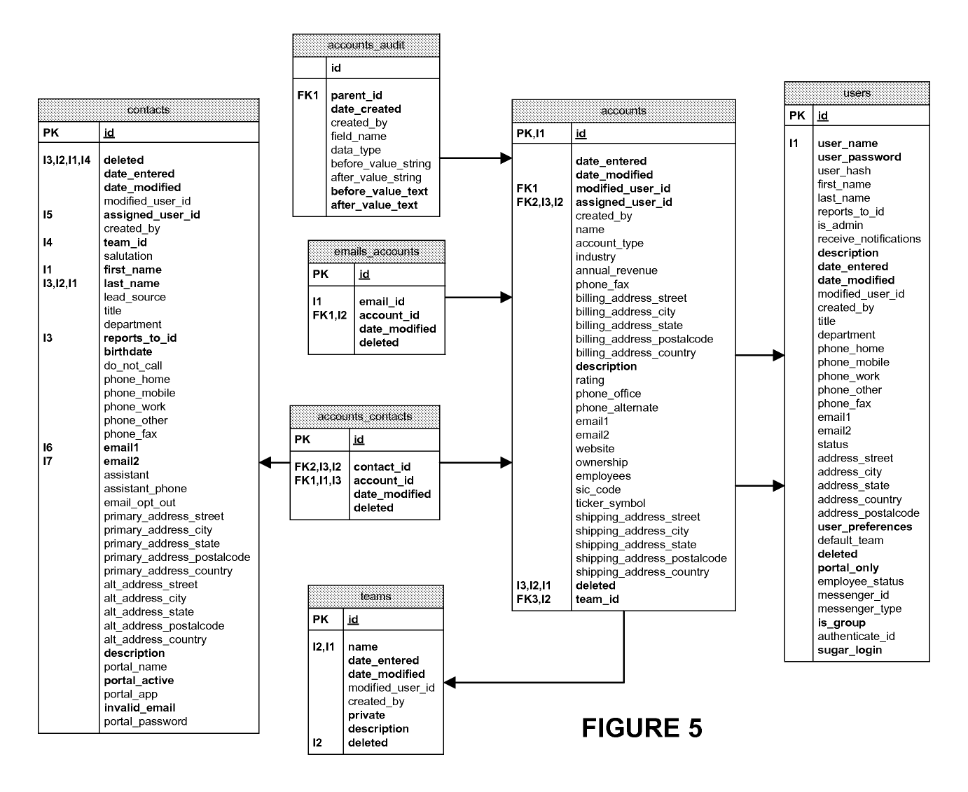

FIG. 5 is a partial view of an account schema that is part of the SugarSuite DB Schema. The account table is at the center and many of the related tables and relationship tables are present. The accounts and contacts tables may be related with a relationship table (Accounts/Contacts) in the middle is a typical example. Appendix A contains a spreadsheet with the seed data for the account table shown in FIG. 5. An example of a sample SQL statement for creating the Accounts table for SugarSuite on a MySQL database is as follows:

CREATE TABLE ‘accounts’ (

‘id’ char(36) NOT NULL,
‘date_entered’ datetime NOT NULL,
‘date_modified’ datetime NOT NULL,
‘modified_user_id’ char(36) NOT NULL,
‘assigned_user_id’ char(36) default NULL,
‘created_by’ char(36) default NULL,
‘name’ varchar(150) default NULL,
‘parent_id’ char(36) default NULL,
‘account_type’ varchar(25) default NULL,
‘industry’ varchar(25) default NULL,
‘annual_revenue’ varchar(25) default NULL,
‘phone_fax’ varchar(25) default NULL,
‘billing_address_street’ varchar(150) default NULL,
‘billing_address_city’ varchar(100) default NULL,
‘billing_address_state’ varchar(100) default NULL,
‘billing_address_postalcode’ varchar(20) default NULL,
‘billing_address_country’ varchar(100) default NULL,
‘description’ text,
‘rating’ varchar(25) default NULL,
‘phone_office’ varchar(25) default NULL,
‘phone_alternate’ varchar(25) default NULL,
‘email1’ varchar(100) default NULL,
‘email2’ varchar(100) default NULL,
‘website’ varchar(255) default NULL,
‘ownership’ varchar(100) default NULL,
‘employees’ varchar(10) default NULL,
‘sic_code’ varchar(10) default NULL,
‘ticker_symbol’ varchar(10) default NULL,
‘shipping_address_street’ varchar(150) default NULL,
‘shipping_address_city’ varchar(100) default NULL,
‘shipping_address_state’ varchar(100) default NULL,
‘shipping_address_postalcode’ varchar(20) default NULL,
‘shipping_address_country’ varchar(100) default NULL,
‘deleted’ tinyint(1) NOT NULL default ‘0’,
‘team_id’ char(36) default NULL,
PRIMARY KEY (‘id’),
KEY ‘idx_accnt_id_del’ (‘id’,‘deleted’),
KEY ‘idx_accnt_team del’ (‘team_id’,‘deleted’,
‘assigned_user_id’),
KEY ‘idx_accnt_assigned del’ (‘deleted’,‘assigned_user_id’),
KEY ‘idx_accnt_parent_id’ (‘parent_id’)

)ENGINE=InnoDB DEFAULT CHARSET=utf8

Upgrade and Installation Files

DCE may include the capability to automate detection, download and execution of software upgrades based on the information provided by a remote server as well as local installation/modification metadata created by the DCE on the target system in response to user actions. A remote server mentioned above may be a server that the system knows to go to in order to look for and/or download updates. Once connected to the remote server, in addition to looking to see if new updates are available, the system may download the new updates directly from the server. These upgrades can be executed either manually or automatically by the system. To enable this the upgrade files must contain template components and instance components. The template components may include files to copy or replace on the target system and/or any scripts necessary to execute the file upgrade. The instance components may include files to copy or replace on the target system, any scripts necessary to execute the file upgrade, a database schema to copy or replace on the target system, and/or any scripts necessary to execute the database upgrade.

Deployment Management

Deployment Management allows SugarSuite administrators to create, delete, deactivate and otherwise manage distributed SugarSuite installations. Deployment Management spans Template management, Instance Management, License Management and Access management, each of which is described in more detail below. Each Instance is associated with a Template; in other words Templates->Instance relationship is one-to-many.

Templates allow DCE administrators to logically and functionally organize their installations of SugarSuite. Multiple Sugar instances extending a single Template will share all specific functionality of that template amongst them. However, they can further individually enhance those customizations. This kind of organizational model for shared-tendency installations will allow for simpler methods of managing, installing and removing new instances of the software. In the illustrative embodiment, all the deployment management functions are subject to Access Control rules.

Template Management & Functionality

The template management may include one or more of the following functions:
1. Create/Download new Template:
   Allow users to choose version
   Allow users to choose associated modules (a.k.a Project Management Module, etc.)
   Allow users to choose product (a.k.a. SugarSuite, Portal, etc.)
2. Copy and clone template (primarily for customization). This process may be done when the user wants to create multiple instances that share substantial customizations.
3. Delete template
   Available only for templates that do not have associated instances.
4. Deprecate a template
   Allow current instances of this template to continue functioning normally; prevent creation of new instances from this template without impacting the existing ones.
5. Upgrade a Template

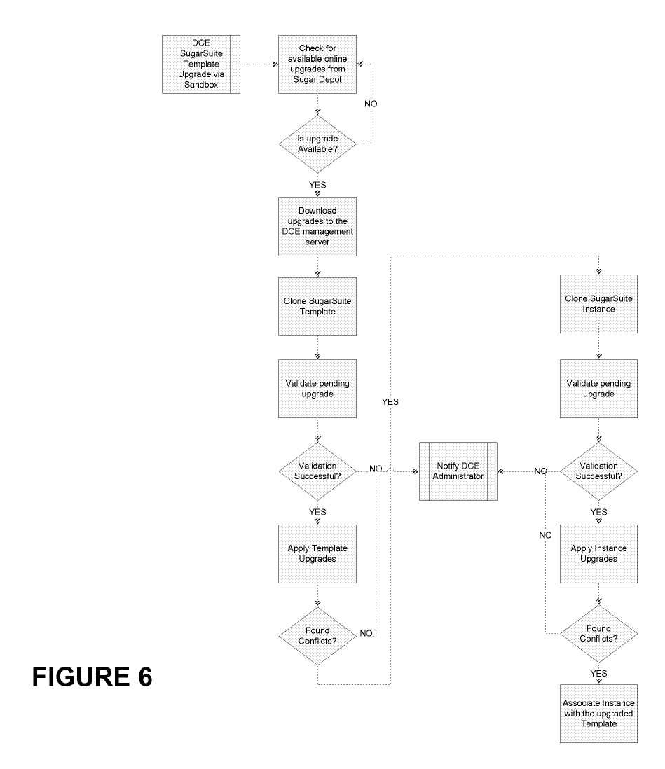

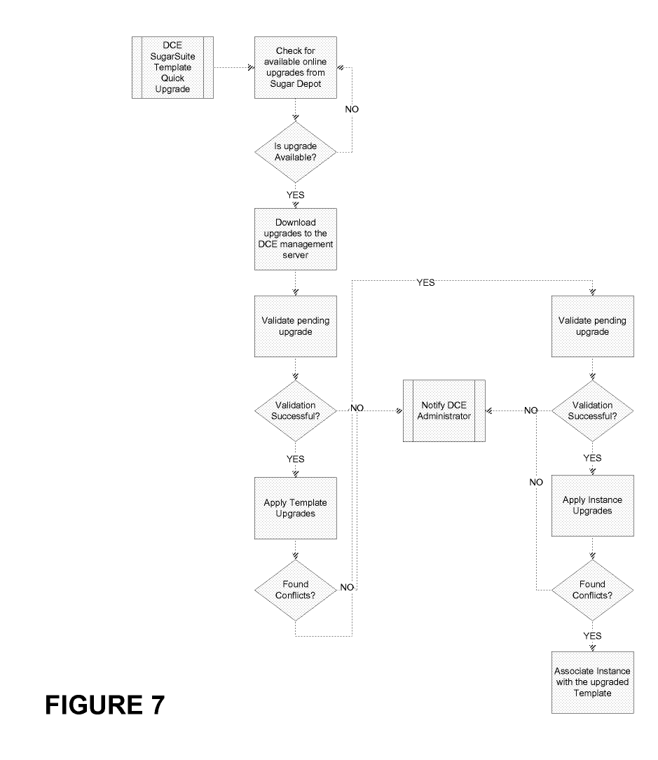

Template upgrade can be fully automated, partially automated or a fully manual process. Two main kinds of upgrades will be readily available: a Sandbox Upgrade (see the exemplary method shown in FIG. 6), which will create a complete replica of all relevant files in the current installation, execute and validate the upgrade, run automated sanity checks and make the new environment available for user acceptance testing and a Quick Upgrade (see the exemplary method shown in FIG. 7), which will execute validation and consequent upgrades directly on the live installation. Some of the different upgrade options may include:
DCE configuration to automatically download new updates for any version of Sugar that is DCE-ready to be applied to any templates.
DCE configuration to automatically apply security patches to templates based on the patched product.
DCE configuration to automatically apply general patches to templates based on the patched product.
DCE configuration to automatically apply new versions and upgrades to get to new versions.
DCE configuration to automatically extend upgrades to associated child instances. DCE configuration to execute upgrade on the template via creation of a clone (sandbox) environment:
   Clone an existing template that is affected by the patch or new version.
   Validate patch to be applied.
   Apply the patch and/or new version to the new template.
   Run upgrade.
   Detect and analyze any conflicts. In an interactive mode, the method suspends the process and prompts for user intervention to resolve conflicts while in automated mode, the process is aborted and the administrator is informed.
   Proceed to clone and migrate associated instances.
6. Configure a Template
   Configure automatic patch and upgrade download.
   Configure automatic patch/upgrade application options for the template.
7. View and Inspect
   List All Templates
   List All Instances of a Template
   Report on Instances and Templates
   Visually Indicate templates and instances that have upgrades/patches available
   Visually Indicate templates and instances based on usage levels.
   Visually Indicate templates and instances by Sugar Version.

Implementation Paradigm

Templating feature may be implemented in various ways to conform to specifics of the environment including, but not limited to: languages, interpreters, and platforms. Regardless of the specific implementation, effective caching may be an important contributor to performance. Sharing common files and loading directly from a common template will decrease the number of files loaded and parsed and will boost cache effectiveness. A few proposed methods for implementing the templating feature are the follows:
Implementing templating via intercepting file streams. When the language includes a file, automatically intercept the request and decide where to pull the file from based on the template configuration.
Utility Functions, which provide a centralized way to retrieve the full path of the source file that should be used when a file inclusion is attempted. In one embodiment this utility is called SugarTemplateUtils.

In the exemplary embodiment, a single tier of templates is supported, but multiple tiers of templates may also be supported. An example of a multiple tiers of templates would be an environment where there may have a base template as shipped from Sugar. There may then be a template created based on that template that provides extra functionality and/or changes the system to be targeted to a specific audience like a real estate vertical. Specific instances may be created based on any level of the template. A user may create an instance based on the original code, or the real estate vertical. When updates are applied, the user can roll the updates down through the layers of templates. This extra capability of templating may help the user maintain customizations from which multiple templates are derived.

Instance Management

A SugarSuite Administrator must be able to manage a range of SugarSuite instances, modify/customize those instances, and perform other management duties as listed below. Zero or more SugarSuite instances might be linked to a Template, but each instance is associated with only one template. As with the other deployment management functions, the Instance Management functions are subject to Access Control rules.

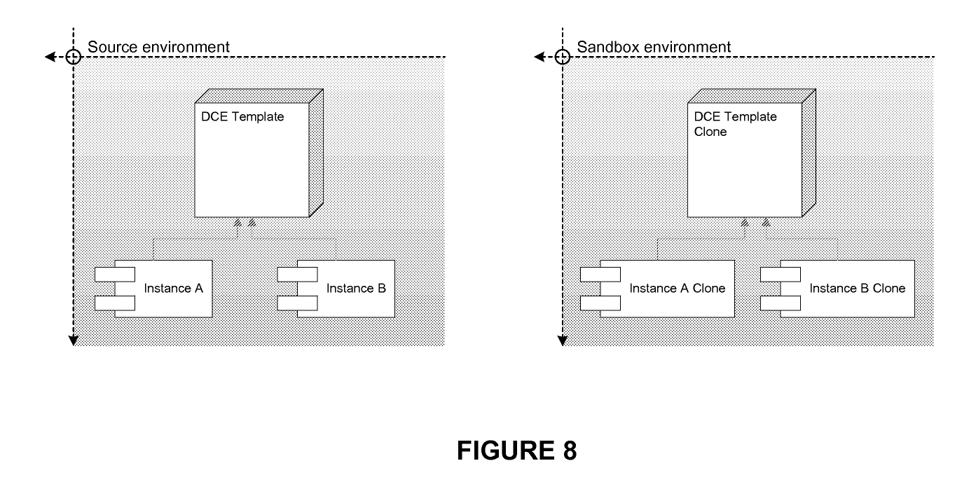

One specific type of SugarSuite Instance is a Sandbox Environment. A sandbox environment exists to validate functionality, perform tests, allow for online development and other management functions. FIG. 8 shows the source environment and the sandbox environment wherein there are two instances (Instance A and Instance B) based on the DCE template for the source environment and there are two clone instances (Instance A Clone and Instance B Clone) for the DCE template Clone for the sandbox environment. This logical type of instance can be highly restricted or can allow full access. Some of the specific instance management functionality below pertain mostly to sandbox instances.

1. Create new Instance
Create a new instance from a chosen Template. This process should automatically select and configure deployment resources without manual intervention (for example if the current server is full, the instance should be created and deployed on a less impacted server). This will require defining meta information about the servers and set limits when new servers should be allocated.
Allow the user to set “auto-expire” timer for this instance.
Select supported DB vendor for this instance.
Allow the user to select application server.
Setup all configuration files accordingly (Inbound Email, DB Connection, . . . , User Preferences).

2. Delete Instance
Allow for “expiration timer” to automatically remove instances if “auto-expire date” has been set. This is useful for demo or sandbox instances.
Remove all associated services (a.k.a. mail, CVS).
Deactivate Instance (i.e. make inaccessible to users, but do not delete files, services or DB schema)

3. Clone Instance. This is useful for sandbox instances.
Clone Instance Files.
   The user can choose to copy all instance files to the new host location.
   The user can choose to NOT copy attachment files.
The user can select another DB vendor (note schema must be interchangeable and the cloning process must adapt configurations accordingly)
Allow the user to select application server.
Allow the user to set “auto-expire” timer for this instance.
Allow the user to select another template.
An optional copy of the DB schema will be created. Creation options are as follows:
   The user can copy all data from donor schema. The application should display the size and estimated time to copy.
   The user can create an empty copy of the donor schema (no data present).
   The user can create an empty copy of the donor schema and populate this with seed data.
   The user can create a copy of the donor schema with some data removed or mangled. There may also be a tool that will analyze the number of records in the database of each type and the proportions among the relationships. This tool may then be able to create a similarly sized and proportioned database that is entirely composed of random data.
   The user can skip schema creation and allow the clone instance to use donor schema.
   The user can skip schema creation and allow the clone instance to use donor schema for read only.
Set up all services for this instance.
   Set up CVS branch.
   Set up new servers (a.k.a. mail)
   Setup “fake” servers (a.k.a. FakeMail for email testing).
   Setup configuration files for components (Inbound Email, DB Connection, . . . . User Preferences).

4. Instance Editing
Allow users to check-out & edit instance files.
Track all changes to DB Schema, File, and UI.
Allow user to Undo/Redo changes.
Seed Data (useful for Demo Instances)
Associate/Re-associate Instance to a Template.
Back-up/check-in/merge files.

5. Upgrade to Template
Convert application Instance to Template.

6. Deployment
Create deployment package from an active instance. The following options apply:
   Use current DB data.
   Use current DB schema (no data).
   Create install scripts for
      1. Instance Files
      2. DB Schema
      3. Services and configurations
Export Customizations
   Exports may contain some or all of the changes made to a system. Changes may be selected based on type of change and/or modules affected. Examples of types of change that may be exported include:
      1. Custom Fields (all, additions, removes, modifications)
      2. Metadata files (user interface, data model, logic control, . . . )
      3. Language Packs (UI labels, messages, warnings, . . . )
      4. New Modules (UI, Data, Schema, logic, integrations, sub panels, . . . )
      5. Upgrades Applied and/or Modules Loaded (Schema changes, business process, data manipulation, file manipulation, . . . )
   Exports may be compressed using a common compression technique such as Tar-Gzip or Zip.
   Exports may be complete or based on a particular state of the system. For instance, if the user has made a lot of customizations and then create a sandbox, the user can export all changes, or changes made since that sandbox was created. This allows quick and easy additional changes to be exported from a heavily customized instance.
Import Customizations
   Imports support bringing in changes from exports done on other systems. The user may be able to choose which type if changes to import and/or filter the import based on module. For example, you may want to pull in only the UI layout changes that were made to the contacts module.
   Imports support all of the change types supported by export.
   The import process may perform a merge of the changes. If there are conflicts, there may be an automatic mode where one of the two sets wins (either the set being imported, or the existing set). There may also be a manual mode that allows a human to decide which change wins in the event of a conflict.
   There may also be a mechanism to show some of the changes and/or conflicts in the User Interface to allow the user to see what the conflict is and potentially merge specific portions of the changes into a final result. One example would be to show three views of a customized user interface: the two conflicting views and the target. From this view, a user is able to select which result the user likes better from the other two views and potentially make additional changes directly in the target view.
   Filtering and merging mechanisms on import provide a great ability for multiple people to work on multiple development copies and then choose the best results they have produced and merge those changes into their production application. This capability may also be an excellent way for customers to work with sandboxes to not have to worry about additional changes they may have made. They can selectively choose the changes they want in order to specifically filter out changes they don't want, or to only bring in changes they do want. This helps ensure they do not accidentally bring in some unwanted changes into their production instance.
Setup Instance Monitoring (as described in Monitoring Section)
Synchronize two instances via encrypted back-channel (useful for OnDemand to OnSite transitions)
Migrate to another web cluster.
   Allocate space on a new node.
   Copy the web application and database to the new node
   Shut down the web application on the current node
   Perform a final synchronization of the entire application. This should be very fast since the content was already copied and only the updates need to be migrated.
   Redirect inbound traffic for that application to the new node.

7. Permissions
Set access permissions, roles and groups on a specific Instance: Admin, Developer, User (as described in the ACL section)

8. Monitoring
Turn on/off monitoring/logging for DB, SugarSuite Instance.

9. Other
Upgrade Instances between templates.
   Take an existing instance that is running against a 4.5.0 based template.
   Select a 4.5.1 based template to migrate it to.
   The system will apply the necessary file changes, file manipulations, database schema changes and data manipulations to make the instance compatible with the new template.
   Associate the instance with the new template.
Web Servers ping control server to check for work.
   Make sure polling is safe from race conditions.

System & Cluster Management

System or Cluster administration functions allow the DCE administrators to set-up, assemble, configure and destroy clusters of SugarSuite installations across a range of servers. A cluster consists of a number of “virtually headless” web servers (these might include “specialized” servers that handle reporting, static content, chronicle jobs) or an NFS mount for the file system and a DB cluster. Each web server must be configured with a set of rules to discover the SugarSuite Instance referred to by the request URL. Each SugarSuite instance may include the following configuration files for access to the DB cluster:
Set permissions of SugarSuite Instance files.
Configure NFS mounts for web server cluster.
Output Stack configuration on each Web server.
Clean Server cache
Run system integrity scans (i.e. check relationship tables and clean up spam)
Run a simple automated test against a SugarSuite instance.
Run a simple security scan against a SugarSuite instance.
List all customized files.
Stack Support:
   Analyze current stack make sure it is supported.
   Allow the user to upgrade to a supported stack.
Configure web server (IIS/Apache)
View log file from the web servers; SugarSuite Instances (with error reports & highlights)
Maintenance requirements:
   Setup Scheduled tasks/maintenance windows (with optional email list for notification to affected parties).
   Setup Maintenance page during maintenance window with message.
   Setup general DB monitoring.
   Migrate instances between clusters (a.k.a from OnDemand to DCE OnSite)

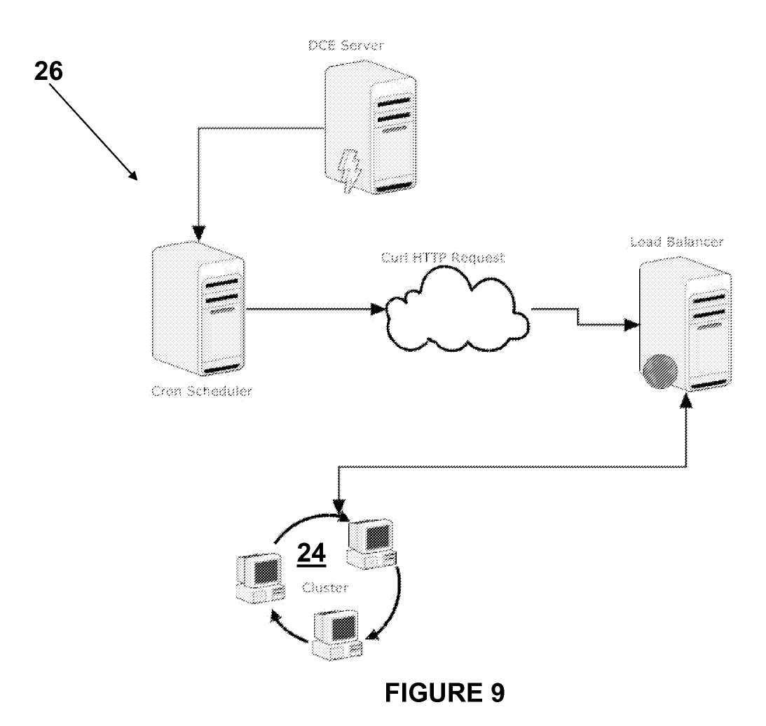

FIG. 9 illustrates a cluster of servers 26 that includes the DCE servers that are connected to one or more centralized schedulers which abstracts all asynchronous jobs of each individual instance into a centrally executed task. The goal of this feature is to alleviate and to control the load generated by individual servers and to enable single point of control for the system administrator. Centralized scheduling allows for the control of resource usage devoted to scheduled tasks. Centralized scheduling allows limited resources to be spread among the highest priority tasks. The centralized scheduler may have a table that stores the instances, the scheduled jobs for the instances, when they were last run, and/or when they are next due to be run. The centralized scheduler may then leverage this information to distribute work to a single machine that is processing the scheduled items, a cluster of machines dedicated to processing scheduled items or to the web servers in the cluster running the application.

Online Instance Management & Dynamic Reallocation

DCE may provide a User Interface to manage dynamic application functions. The system may allow for the following runtime tasks:
Provisioning and de-provisioning of SugarCRM instances.
Migration of active SugarCRM instances based on server performance or cluster utilization.
Start-up and shut-down of individual SugarCRM instances.
Online migration for updates.
   To implement a zero-downtime online upgrade process various algorithms may be used. A simple process is creation of a “shadow database” and an upgraded instance folder to implement the upgrade. The instance URL can then be routed to the new upgraded version. To implement a zero-downtime modification of the schema, a new table may be created with the new schema for an exiting table. The existing table may be moved out of the way, and the records may be moved from the original table to the new table. By using this technique, the system can have schema modifications made without causing large periods of time where the system is not available. This technique allows the system to continue to function with some of the data not available. This may be a far more preferable situation than a large downtime window.

Tracker

The system may implement a mechanism for tracking and reporting on system-wide dimensions, application coordinates (delivered via heartbeats), and change logs. Examples may include
Query tracking and aggregation for all application instances
Adjustable application and platform configuration parameters (e.g. DB, memcache, etc.).
Data rollup to DCE master.

Product Change

The DCE may also support product change. The product change functions may include one or more of the following:
Remove all application instance features not applicable for cluster environments (such as backups)
Swap out the load paradigm as all included/required files must use functions or classes.
   Include better ability to split the files along arbitrary paths
   Allow concurrent editing of different places.
Lock down customizations and direct file access
Lock down queries
Lock Down module loader/upgrade wizard/administration panel
Allow selective administration of components (release management, drop downs, . . . )
Allow Team/ACL/Role administration
Improved Caching
   Break Screen into regions that are independently updated
   Have client side queue for sub-panels, dashboards and/or dashlets and everything that is Ajax-based
Delete old upgrades from the file system.
Delete non-reversible upgrades
Support backup before modifications
   Targeted at code files and caches (may include uploads, . . . )
Check pointing
Auto-Recovery of instances
Quick check of site/instance status. If the instance is down, diagnose the system. Report on status.
Report on outages for each instance. Track client requests during outages. Replay simple input forms (i.e. lead capture).

### Monitoring Reporting and Alerts

The DCE may provide monitoring, reporting and alerts that may more specifically include monitoring and backups (system and instance monitoring), backups, reporting, dashboards and alarms.

Monitoring & Backups

Administrator must be able to monitor system performance, application performance across Instances and Application Performance on per-instance basis. Two types of monitoring should be implemented: System Monitoring and Instance Monitoring. System monitoring may provide information on all components in the cluster (Servers, Routers . . . ). Application monitoring will provide data specific to every individual instance of Sugar's performance across the DCE cluster. The cross-section of server-application performance may provide valuable insight into the overall performance of the cluster and allow for further tuning of servers and instances.

System Monitoring

Administrator should be able to monitor system performance, application performance across Instances and Application Performance on per-instance basis. The system monitoring allows administrators to monitor performance of the system running SugarSuite Instances and the following system parameters will be available: Server names or IPs being monitored and statistics (current) for each Server: CPU, Memory, disk utilization (throughput levels and space percentage), Number of Concurrent Live Sessions, any currently blocked requests (Locked Queries, connections waiting on a server, connection pool limits reached, . . . ) and/or component specific response times that may include server response times, database response times and routing delay.

Instance Monitoring

The monitoring may also allow the Administrator to monitor the current instances of Sugar in the DCE ecosystem. An instance of the application can be deployed on numerous physical servers and multiple logical servers (clusters). The monitoring information needs to be forwarded to DCE to provide a reconciled view of the information provided by the System Monitoring component to create a coherent picture of the DCE ecosystem. The data on the performance of each instance will then be available. The following performance information may be available to the DCE Administrator:
Query response times (sorted by query type and response time per DB server)
Server response time per page request (sorted by request type/module/action and response time per server).
Cache hit ratios
Concurrent user count and percentages (How many concurrent users is the system handling? What percentage of total users does this represent?)
Instance-to-server ratios and performance matrix
Total installation information:
   Number & List of Instances (active, evaluation, test/demo, etc.)
   Number of Users total and per Instance (active, evaluation, test/demo, etc.)
   Number of Accounts (active, test, etc.)
   Current Level of Sandbox activity
Sugar Specific Metrics (Per server, for all servers, for each instance, for each customer). All of these metrics should have a baseline and automatic comparison. The baseline will allow the system to determine and present to the user if there are any issues, and the automatic comparison should provide incremental feedback as to changes in the performance of the system (is it slowing down, speeding up, . . . by what percent or at what rate)
   Round trips (total, this month, today, last hour, last 5 minutes, . . . )
   Round Trip statistics (average response time per server, per module, per module/action, . . . )
   Instance Statistics (numbers created, active, destroyed, . . . )

Information from instance monitoring should be made available in a user interface (UI) that presents the user with high level information and allows them to drill down. The information should also be filterable by date/time, instance, module, action, and response time. These filters should be able to be used in any combination. This level of filtering presents a unique way to view the performance of the server. The user can start at a high level UI that shows there is some degradation of performance. The user can then drill in and see that the issue appears to being caused by one instance on a cluster. The user can then drill into that instance and see that one module is causing most of the slowdown and it appears related to list views on that module. With this information in hand, the user can look at individual page tracking to see if all list views are a problem or just ones that are filtered in a particular way. This drilling down process on the logs gives the user a very powerful view into the system and will highlight any problems or places that the user can tune.

Backups

Administrators should be provided with basic data management capabilities, including automated system back-ups. System back-ups and other administrative tasks can be scheduled at a particular time in the day/week/month and with a specified frequency (by hour, day, week, . . . ):
Back-up an Instance to a local NAS (including setting up automated back-up schedule or customer through the UI) or a remote server.
Restore an Instance from a backup
Export Instance Data (to CSV, Excel, etc.)
Requests for Backup and Export should either be scheduled in advance or support queuing to allow for them to be throttled to mitigate any performance impact to users.
Export data to a new DB target:
   MySQL to Oracle
   MySQL to SQLServer
Migrate an instance from one cluster to another (single step). This step will likely be composed of the following sub-steps. If the system is not local or is isolated, the data transfer can take any form (from shipping a server, to shipping a hard disk, transferring the files, shipping a CD, . . . ).
   Pack current instance for migration to another cluster.
   Transport data to the new cluster
   Unpack instance on a cluster

Analytics

DCE should enable basic analytics capabilities for the clustered deployment. DCE should gather and reconcile data from different instances and servers to be presented in a coherent manner. DCE server should introspect this information and be able to take action to heal the cluster if possible. Alarms should be configurable and be triggered on appropriate events (including the system not having the ability to automatically remedy an issue). The analytics component should work based on one or more of the following threshold parameters:

Average response time.

Response time inappropriate for the module, action, or module/action combination

Specific response time (for specific query/url).

System usage levels (CPU, Disk space, disk percentage, memory, . . . ).

The DCE engine should be able to:

Shut down/start/re-start a process

Remove server from the cluster active server pool to cluster standby server pool.

Take a new server from the standby list and bring it into a cluster.

Migrate instances from an impacted cluster to one of the standby clusters.

Send alarm when system state is critical.

Business Intelligence and Reporting

The reporting is a key component enabling the DCE to run and service clusters autonomously. Reporting will automate essential IT processes to provide and send-out up to date information of uptime and performance of the cluster components as a whole and each individual implementation. DCE should expose this information through an API for seamless integration into other monitoring tools. Reports should also provide an overview of the installations and composition of the clusters to the system administrators.

The following out-of-the-box system reports should be available to the Administrator.
Total Instances vs. Paid vs. Demo vs. Evaluation (by instance type, by template, by customer, un-grouped . . . )
Total number of servers in use, overall usage statistics including average response times.
Monthly per-instance and overall Uptime reports (scheduled and emailed automatically on a configurable schedule).
Uptime/performance reports (regularly scheduled or on request).
Tracking usage limits (transactions, footprint, bandwidth, queries, CPU time, . . . ) and providing a list of people that are approaching, going over, or over one or more of their limits.
Billing tracking (not a requirement for 1.0). How many resources did they consume (this needs to be automatically tracked for any billable resource).
Customer usage reports and alerts. Is a customer using the system more or less? How much are the customers for a particular administrator, sales representative, or support representative using the system?
Usage Reports Sent to Customers. These should show the adoption of the system to the customer. They should report individual usage, group usage, module usage, . . . . This information can be used to track the adoption of the CRM system, validate the value they are getting from the system, and provide a great means of driving more adoption. If system usage of certain aspects is low, we can refer them to training resources for those aspects. When they opt out of an aspect (say customer support), we should have a system in place to track that so that we do not regularly keep suggesting to them that they make better use of the support related modules.

Instance data aggregation and consolidation, querying, and analysis from all managed instances for the purposes of deriving cross-organizational or cross-departmental metrics and systems. This may be implemented by providing a uniform interface into all individual instances managed by the DCE application. Queries and analytics may utilize this interface to create a framework for organizing, automating and optimizing business processes managed by multiple SugarCRM core applications.

Dashboards

The system should provide a dashboard with all monitored Key Performance Indicators. This should have functionality similar to Sugar's reporting module. In its preferred form it will be based on the Sugar reporting and dashboard framework (with support for flash charts/graphs, tabular views, filters, printing to PDF, and export to CSV.) The following reports may be provided:
Number of instances created in the last n days
average number of instances created in the last n weeks/months
Top 10 resources utilizers by instance (by resource)
Top 10 most active instances
Top 10 largest instances by database size
Top 10 largest instances by number of user
Resource usage per cluster and/or server
Overall instance allocation—pie chart for active, evaluation, sandbox, demo
Version composition including which template they are based on, which version of that template, what version of Sugar the template is based on, . . .

Alarms

Alarms alert system administrators if one or many of the DCE-managed instances in the cluster are acting abnormally. Alarms should be configurable based on time/performance/resource utilization thresholds. DCE should also detect if multiple instances are having problems, log the information and aggregate multiple incidents into a few targeted alarms to avoid flooding the network if a significant outage is in progress. If there is a problem with a cluster, for instance, reporting for each instance on that cluster would flood the alarm infrastructure and hamper repair efforts. The Administrator must be able to configure watermark and time-based alarms for various system monitoring components. The System must be able to perform proactive monitoring and automated self-notification as a means to verify that:
An http(s) request can be completed and response received within a predetermined number of seconds.
Sessions can effectively be established within a predetermined number of seconds.
Server response time for the non-customized login page falls at or under 30 seconds.
No request takes longer than a predetermined number of seconds to complete.
DB query locking, exceeding thresholds and timeouts.
Number of server requests in excess of a configured parameter. Number of sessions in excess of a configured parameter.
Server utilization in excess of a configured parameter.
   This request tracking system should be tunable by module, action, and module/action pairs. The dashboard module takes a lot longer to respond on average than a typical detail view.

Alarms should be templates that are reused. These templates should have the following parameters:
contact mechanism (email, phone, SMS, . . . )
Addressee (phone number, email, etc.)
Time threshold.
Escalation procedure: messages might be scheduled to be sent to a specific and distinct targets based on priority, severity, lapsed time, etc.

License Management

The DCE may provide license management. The license management functions may include:

License acquisition

Periodic automated license renewal (monthly, quarterly, yearly, etc.)

System should gather all licensing information and report in batch to Sugar.

All usage heartbeats should go to DCE first, instead of the primary SugarCRM servers.

Update license information (for any changes such as extensions, date changes, etc.)

Bulk license management

Add notification if license limits are getting close or exceeded

Add Upgrade notices

Add cart integration to purchase more licenses

Apart from managing the licenses of instances, DCE should have provisions to manage its own licenses. This is important when DCE is sold to other hosting providers and also as part of Sugar Enterprise edition

Expiration of licenses

Permitted number of instances exceeded

Bulk license seats available

Free incremental seats available

Cost for incremental seats (if they have pre-paid, this may be 0)

Incremental seat batch count (if they buy increments of 50 seats, . . . )

Acquire, Upgrade and Renewal Processes for new instances

### User Management & Access Control

Access Control encompasses two kinds of user administration: DCE users/roles management and SugarSuite user/role management.

SugarSuite ACL Management:
Create user groups and their roles/associated permissions for data read/write access/visibility. It may also allow multi-role associations.
Create users.
Associate user with a roles/group.

The following are requirements for all Sugarsuite Customers:

Support case portal going to DCE instead of straight to Sugar

Customers have no direct file access

Application ability to lock down:
Backup
Module Loader
Upgrade Wizard

DCE ACL Management:
Create users: (names based on logged-in user) and random passwords for support users. Show the user/pass in the DCE Instance Management user interface.
   Support user-name pre-pending. When an administrator of DCE logs into a customer instance the system should automatically create a new user for that login using the user-name the administrator is currently logged into DCE under and a prefix to let the customer know that this user is an administrative user.
   Improve user configuration. The system may have tools to automatically configure different types of users with different preferences. It may also be able to clone an existing user (their teams, preferences, . . . ) for the purposes of reproducing and/or diagnosing issues.
   Destroy support users when they are old. When a user is no longer needed, it should be removed to clean up the user table of the instance.
Create DCE roles/groups:
   DCE admin, NOC, guest, etc.
   Add default team for users of DCE (similar to the current product) so that new records created by them will be owned by to their default team.
   Add the ability to assign records to the global team to provide visibility for all users

While the foregoing has been with reference to a particular embodiment of the invention, it will be appreciated by those skilled in the art that changes in this embodiment may be made without departing from the principles and spirit of the invention, the scope of which is defined by the appended claims.

1. A software data center edition system, comprising:
a computer installation;
one or more nodes in the computer installation;
each node having a plurality of computing devices wherein each computing device operates on a software platform and executes a deployment of a software application on the computing device so that the deployments of the software application are distributed across the data center; and
the computer installation having a data center edition application that administers the installations of the software application distributed across the computer installation and provide a unified application management console.

2. The system of claim 1, wherein each deployment further comprises a virtual host folder with a set of code for the deployment, a link for a folder containing an instance of the deployment, a database schema instance or a database instance.

3. The system of claim 2 further comprising a template wherein each deployment is an instance associated with the template.

4. The system of claim 3, wherein the template further comprises an unmodified release or patch version of the software application or a customized release of the software application.

5. The system of claim 1, wherein the computing device is a server computer.

6. The system of claim 1, wherein the software application further comprises a customer relationship management software application.

7. The system of claim 6, wherein the customer relationship management software application further comprises a SugarCRM customer relationship management software application.

8. The system of claim 1, wherein the software platform further comprises a Linux platform, a Windows platform, a database platform or a web server platform.

9. The system of claim 3, wherein the data center edition application further comprises a template management application that manages the templates used for an instance of the application.

10. The system of claim 9, wherein the template management application further comprises a sandbox upgrade that creates a complete replica of a current installation to perform the upgrade.

11. The system of claim 9, wherein the template management application further comprises a quick upgrade that creates a complete replica of a current installation to perform the upgrade.

12. The system of claim 1, wherein the data center edition application further comprises an instance management application that manages the instances of the application in the data center.

13. The system of claim 12, wherein the instance management application further comprises a zero-downtime upgrade unit that creates a shadow database and an upgraded instance folder to implement the upgrade and reroutes a URL to the upgraded instance folder when the upgrade is complete.

14. The system of claim 1, wherein each node has a store and the data center edition application caches files in the store that do not exist.

15. A method for distributed software application management in a computer installation, the method comprising:
providing one or more nodes in the computer installation and each node having a plurality of computing devices wherein each computing device operates on a software platform;
executing a deployment of a software application on the computing device so that the deployments of the software application are distributed across the computer installation;
administering, using a data center edition application, the installations of the software application distributed across the computer installation by providing a unified application management console.

16. The method of claim 15, wherein each deployment further comprises a virtual host folder with a set of code for the deployment, a link for a folder containing an instance of the deployment, a database schema instance or a database instance.

17. The method of claim 16 further comprising a template wherein each deployment is an instance associated with the template.

18. The method of claim 17, wherein the template further comprises an unmodified release or patch version of the software application or a customized release of the software application.

19. The method of claim 15, wherein the software application further comprises a customer relationship management software application.

20. The method of claim 19, wherein the customer relationship management software application further comprises a SugarCRM customer relationship management software application.

21. The method of claim 15, wherein the software platform further comprises a Linux platform, a Windows platform, a database platform or a web server platform.

22. The method of claim 17 further comprising managing the templates used for an instance of the application.

23. The method of claim 22, wherein managing the templates further comprises implementing a sandbox upgrade that creates a complete replica of a current installation to perform the upgrade.

24. The method of claim 22, wherein managing the templates further comprises implementing a quick upgrade that creates a complete replica of a current installation to perform the upgrade.

25. The method of claim 15 further comprising managing the instances of the application in the data center.

26. The method of claim 25, wherein managing the instances further comprises performing a zero-downtime upgrade that further comprises creating a shadow database and an upgraded instance folder to implement the upgrade and rerouting a URL to the upgraded instance folder when the upgrade is complete.

27. The method of claim 15 further comprising caching, in each node, files that do not exist.
